(19) United States
(12) Patent Application Publication
(10) Pub. No.: US 2026/0056056 A1
(43) Pub. Date: Feb. 26, 2026

(54) Calculation unit, and associated hue determination device, fluid dispensing system and dispensing method

(71) Applicant: EXEL INDUSTRIES, EPERNAY (FR)

(72) Inventors: Ahmed BAIDAOUI, EPERNAY (FR); Nicolas FERRERE, EPERNAY (FR); Ilana MANCEL, EPERNAY (FR)

(21) Appl. No.: 19/298,181

(22) Filed: Aug. 13, 2025

(30) Foreign Application Priority Data
Aug. 20, 2024 (FR) 2408990

(51) Int. Cl. G01J 3/50; G01J 3/02; G01J 3/46

(52) U.S. Cl. CPC G01J 3/501; G01J 3/0218; G01J 2003/467

(57) ABSTRACT

A calculation unit for a device including at least one light source configured to emit light towards a fluid, a light sensor configured to receive a light signal representing a hue of the fluid circulating in a fluid distribution system, the light sensor being further configured to emit parameters representing a light intensity of the light signal for a given color channel, the calculation unit including an estimation module configured to determine a variable representing a hue of the fluid via an artificial intelligence model, each parameter representing a light intensity being an input variable of the model, an output variable of the artificial intelligence model being the variable representing a hue of the fluid.

### CROSS-REFERENCE TO RELATED APPLICATION

This application is a U.S. non-provisional application claiming the benefit of French Application No. 24 08990, filed on Aug. 20, 2024, which is incorporated herein by reference in its entirety.

### TECHNICAL FIELD OF THE INVENTION

The present invention relates to a calculation unit, and an associated hue determination device, a fluid dispensing system, and a dispensing method.

### BACKGROUND OF THE INVENTION

In the context of a coating product application installation, it is known to determine the hue of a fluid such as paint or a cleaning liquid, circulating in a fluid dispensing system, to determine if the correct paint hue is circulating in the system, or if the cleaning liquid is pure, to know the state of cleanliness of the fluid dispensing system. For example, during a hue change operation, it is known to perform a visual check of the fluid sprayed by the dispensing system to verify that the hue change operation is complete, and that the new paint hue is circulating in the system without being mixed with the old paint.

It is also known, for example from FR 3 127 281 A1, to use light sensors to measure the hue of the fluid. For this, it is known to use an optical fiber, which conveys a light signal to a light sensor, the light signal representing the hue of the fluid. However, the use of the optical fiber causes attenuation of the light signal. The value of the attenuation depends on the length of the optical fiber and the wavelengths composing the light signal. Thus, it is necessary to manually calibrate the light sensor to take into account the attenuations caused by the optical fiber so as to correctly determine the hue of the fluid, which is a long and complex process.

### SUMMARY OF THE INVENTION

The aim of the invention is thus to solve these drawbacks and to determine the hue of the fluid more simply and reliably.

For this purpose, the invention relates to a calculation unit for a hue determination device for a fluid dispensing system, the device including:
at least one light source configured to emit polychromatic or monochromatic light towards the fluid in a measurement area;
a light sensor configured to receive a light signal that has been reflected on the fluid or transmitted through the fluid, the light signal corresponding to an optical reflection or to an optical transmission by the fluid, respectively, of the polychromatic or monochromatic light emitted towards the fluid, the light signal representing a hue of the fluid circulating in the fluid dispensing system, the light sensor being further configured to emit parameters, each parameter representing a light intensity of the light signal for a given color channel; and
an acquisition optical fiber configured to convey the light signal to the light sensor;
the calculation unit including an estimation module configured to receive the parameters emitted by the light sensor.

According to the invention, the estimation module is further configured to determine a variable representing a hue of the fluid via a pre-trained artificial intelligence model, each parameter representing a light intensity of the light signal for a given color channel being an input variable of the model, an output variable of the artificial intelligence model being the variable representing a hue of the fluid,
wherein the variable representing the hue of the fluid is:
an index of the purity of the fluid circulating in the fluid dispensing system; or
an indicator of class, among a plurality of classes, with each class corresponding to a predefined hue of fluid.

By means of the invention, the determination of the hue of the fluid does not require manual calibration of the light sensor. Moreover, the use of the artificial intelligence model enables obtaining reliable results without requiring additional steps of light signal processing and by limiting the complexity of the calculations performed, which consume resources and time. Determination of the hue of the fluid is thus simpler for users.

According to other advantageous aspects of the invention, the calculation unit includes one or more of the following features, taken individually or according to all technically possible combinations:
the purity index is a decimal number, preferably between 0 and 1;
the purity index is a binary number,
the purity index then being preferably an indicator of class, among a first class corresponding to the case where the fluid is clean, and a second class corresponding to the case where the fluid is dirty;
the fluid is a coating liquid or a cleaning liquid or an aerosol composed of solid, colored particles suspended in a gas;

The invention also relates to a hue determination device for a fluid dispensing system, including:
at least one light source configured to emit polychromatic or monochromatic light towards the fluid in a measurement area;
a light sensor configured to receive a light signal that has been reflected on the fluid or transmitted through the fluid, the light signal corresponding to an optical reflection or to an optical transmission, by the fluid, respectively, of the polychromatic or monochromatic light emitted towards the fluid, the light signal representing a hue of the fluid circulating in the fluid dispensing system, the light sensor being further configured to emit parameters, each parameter representing a light intensity of the light signal for a given color channel;
an acquisition optical fiber configured to convey the light signal to the light sensor; and
a calculation unit as described previously.

Advantageously, the given color channels are red, green, blue, and clear channels, the parameters representing a light intensity of the light signal for the red channel, the green channel, the blue channel, and the clear channel respectively.

The invention also relates to a fluid dispensing system including a fluid flow circuit, and a hue determination device as described previously, connected in series to the fluid flow circuit.

The invention also relates to a method for determining the hue of a fluid circulating in a fluid dispensing system, implemented by a hue determination device described previously, the method including:
emission of polychromatic or monochromatic light towards the fluid by the at least one light source;
reception, by the light sensor, of the light signal, reflected on the fluid or transmitted through the fluid;
reception, by the estimation module, of the parameters representing a light intensity of the light signal for the given color channels; and
determination, by the estimation module, of the variable representing the hue of the fluid.

According to other advantageous aspects of the invention, the hue determination method includes one or more of the following features, taken individually or according to all technically possible combinations:
the method further includes:
   detection of a fluid change operation when the variable representing the hue of the fluid is modified; and
   with a fluid change operation having been detected, determination of an end of the fluid change operation, when the variable representing the hue of the fluid is substantially constant for a predetermined duration,
the fluid change operation being preferably a rinsing of the system or a hue change of the fluid circulating in the system;
the fluid is a coating liquid or a cleaning liquid.

### BRIEF DESCRIPTION OF THE DRAWINGS

The invention will appear more clearly upon reading the following description, given solely as a non-limiting example, and made with reference to the drawings wherein:

FIG. 1 is a diagram of a fluid dispensing system according to the invention;

FIG. 2 is a perspective and sectional view of a part of the fluid dispensing system of FIG. 1, corresponding to detail A on this figure;

FIG. 3 is a flowchart of a method according to the invention; and

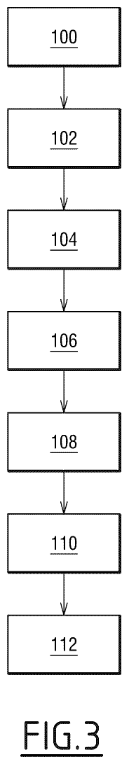

FIG. 4 is a perspective view of a part of a fluid dispensing system according to a second embodiment of the invention, corresponding to detail A on FIG. 1.

### DETAILED DESCRIPTION

The invention is described below in the context of a coating fluid distribution system, for example, paint, for use in a coating product application installation, particularly by spraying. The paint is presented, for example, either in the form of a liquid or an aerosol, composed, for example, of solid, colored particles suspended in a gas. However, this does not constitute a limitation of the invention to this particular application; the invention may be implemented in any fluid distribution system adapted to convey a fluid, wherein it is advantageous to identify the hue of the fluid, notably to supervise operations or phenomena involving a change of hue of the fluid. The fluid may be liquid or gaseous, and, in particular, in the following description, the term fluid includes solid particles transported by a gas flow, or suspended in a gas, particularly an air flow. The solid particles are, for example, colored powders.

In the following description, the expression “substantially equal to” defines an equality relationship to plus or minus 10%, more preferably to plus or minus 5%.

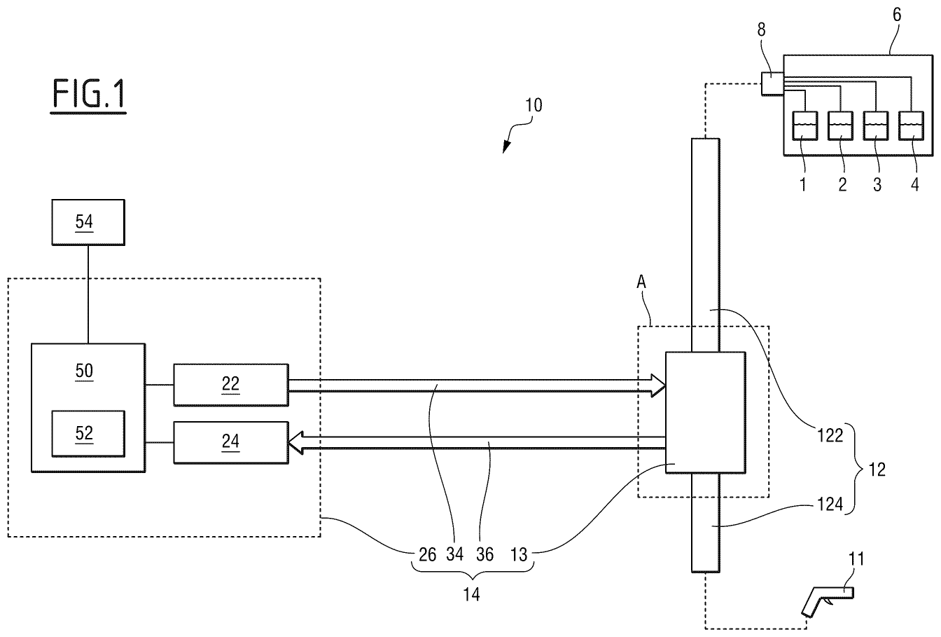

FIG. 1 is a diagram of a fluid distribution system 10. Fluid distribution system 10 is, for example, a paint distribution system, and includes at least one reservoir of paint components, a projector 11, also called a sprayer, and a fluid flow circuit 12.

In the example of FIG. 1, fluid distribution system 10 includes three reservoirs 1, 2, and 3 of different paint hues and a reservoir 4 of cleaning liquid, for example, aqueous, also called solvent. Reservoirs 1 to 4 are grouped in a dedicated room 6, often called a paint room. The number and distribution of reservoirs in the paint room are not limiting. They are adapted according to the intended use for fluid distribution system 10.

A hue change device 8 is supplied by the different reservoirs 1 to 4 and enables selecting which product, paint or cleaning liquid, circulates in fluid flow circuit 12 to supply projector 11.

The projector may, for example, be constituted by a manual spray gun, as shown in FIG. 1. In an unrepresented variant, it is an automatic projector, of pneumatic or rotary type, mounted on the arm of a robot, of multi-axis or reciprocating type.

Advantageously, projector 11 is of the electrostatic type.

Fluid flow circuit 12 includes pipes 122 and 124 and fluidically connects hue change device 8, thus one of reservoirs 1 to 4, with projector 11 via pipes 122 and 124.

Fluid distribution system 10 further includes a hue determination device 14.

A part of hue determination device 14 is connected in series to fluid flow circuit 12, between pipes 122 and 124.

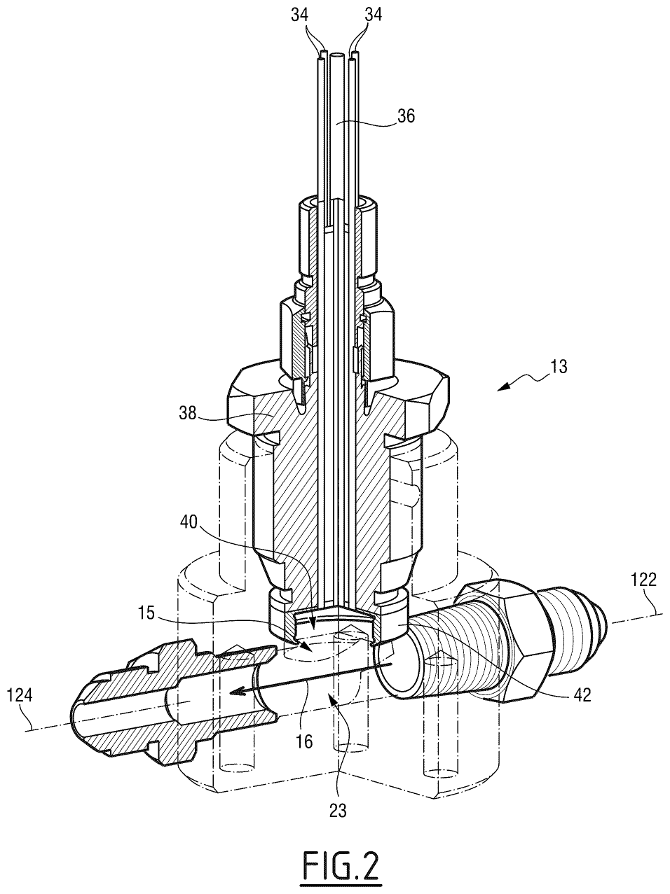

Advantageously, hue determination device 14 includes a flange 13, advantageously opaque, which defines a chamber 15, visible in FIG. 2, through which a fluid flow vein 16 is arranged. Flange 13 is arranged to be connected on either side to the pipes of fluid flow circuit 12. Fluid flow vein 16 is represented by an arrow in FIG. 2.

Hue determination device 14 includes at least one light source 22. It further includes a light sensor 24.

In the example of FIG. 1, hue determination device 10 includes only one light source 22. Light source 22 is configured to emit polychromatic light, i.e., including at least two different wavelengths, or monochromatic, i.e., including a single wavelength. The polychromatic light preferably consists of white light. Light source 22 is, for example, formed of several monochromatic sources, of different respective wavelengths; for example, a red laser source, a green laser source, and a blue laser source, or several light-emitting diodes, or LEDs, of different colors. Alternatively, light source 22 is a light source emitting a continuous light spectrum, such as a filament lamp. Moreover, the light source(s) may be configured to emit pulsed light.

Alternatively, in the case where light source 22 is configured to emit monochromatic light, light source 22 is formed, for example, of one or more monochromatic sources of the same wavelength, for example, a laser or a monochromatic LED.

Light source 22 is configured to emit light towards the fluid, here the paint, in a measurement area 23, represented in dotted lines in FIG. 2 and formed within chamber 15. In particular, the light illuminates the fluid present within flow vein 16, in measurement area 23.

Light sensor 24 is configured to receive a light signal and to emit parameters, each parameter representing a light intensity of the light signal for a given color channel. The given color channels are, for example, a red channel, a green channel, and a blue channel. Alternatively, the given color channels are a red channel, a green channel, a blue channel, and a clear channel, the latter channel representing the light intensity of the light signal taken as a whole. In this case, the parameters emitted by light sensor 24 represent a light intensity of the light signal for the red channel, the green channel, the blue channel, and the clear channel respectively. In other words, light sensor 24 is configured to emit a parameter representing a light intensity in the RGBC or Red Green Blue Clear system.

The light intensity is, for example, and in a known manner, represented by a number between 0 and 255, with 0 corresponding to zero intensity for the considered channel and 255 corresponding to maximum intensity for the considered channel.

It is possible to position light sensor 24 and/or light source 22 near measurement area 23. However, the quality of the distributed fluid or its environment often induces constraints of compliance with regulations for use in explosive atmospheres, of the ATEX type in Europe (for “ATmosphere EXplosive”), as in the context of the paint distribution system. However, the use of a light sensor 24 and/or a light source 22 compatible with this constraint proves costly, and its integration into the hue measurement device is complex, even impossible.

Thus, light source 22 and light sensor 24 are preferably placed at a distance from the fluid flow circuit 12, for example, by being grouped in a processing box 26 which also belongs to hue determination device 14.

To ensure that the light emitted by light source 22 illuminates the fluid in measurement area 23, device 14 includes one or more optical fibers 34, called illumination optical fibers. Illumination optical fibers 34 are advantageously four in number, as visible in FIG. 2. Illumination optical fibers 34 are generally several meters long, for example, at least ten meters, and preferably, they measure up to twenty-five meters. Illumination optical fibers 34 are advantageously connected to light source 22 at one of their ends. The other end of illumination optical fibers 34 is advantageously located in flange 13.

In an unrepresented variant, when device 10 includes several light sources 22, each illumination optical fiber 34 is connected to one of light sources 22.

Device 14 further includes an acquisition optical fiber 36, which is advantageously connected to light sensor 24 by one of its ends, the other end being located in flange 13. Thus, a light signal from measurement area 23 is conveyed to light sensor 24 via optical fiber 36. Acquisition optical fiber 36 is of the same length as illumination optical fibers 34.

Advantageously, means for holding the end or ends of illumination and acquisition optical fibers 34 and 36, such as a cable gland 38, are arranged in flange 13.

Advantageously, device 14 further includes an observation window 40 arranged tangentially to fluid flow vein 16, in flange 13. Observation window 40 notably has the shape of a porthole, as visible in FIG. 2. In the example of FIG. 2, measurement area 23 corresponds to the portion of fluid flow vein 16 visible through observation window 40.

Device 14 advantageously includes a holding element 42 mounted in flange 13, to hold observation window 40 in position and to ensure the sealing of fluid flow vein 16. Holding element 42 may, for example, include a sealing gasket surrounding observation window 40.

Device 14 further includes a calculation unit 50. Calculation unit 50 is connected to light source 22 and light sensor 24 and is formed, for example, of a memory and a processor associated with the memory, not represented. Calculation unit 50 is advantageously located inside processing box 26.

Calculation unit 50 includes an estimation module 52, as visible in FIG. 1. In the example of FIG. 1, estimation module 52 is implemented as software, or a software brick, executable by the processor. The memory of calculation unit 50 is then able to store the estimation software, and the processor is then able to execute the estimation software.

Estimation module 52 is configured to receive the parameters emitted by light sensor 24, then to determine a variable representing a hue of the fluid via a pre-trained artificial intelligence model, the model having, as input variable, each parameter representing a light intensity of the light signal for a given color channel and, as output variable, a variable representing a hue of the fluid. The variable representing a hue of the fluid represents a color of the fluid, or, alternatively or in addition, an opacity of the fluid. In particular, in the case where light emitted by light source 22 is monochromatic, the variable representing a hue of the fluid represents the opacity of the fluid. In the case where light emitted by light source 22 is polychromatic, the variable representing a hue of the fluid represents the opacity and/or the hue of the fluid.

The variable representing the hue of the fluid is, for example, a purity index of the fluid circulating in fluid distribution system 10. According to this example, the purity index is a decimal number, typically between 0 and 1; or a binary number, typically equal to 0 or 1. When the purity index is a binary number, the purity index is advantageously a class indicator among a first class when fluid 10 is clean, and a second class when fluid 10 is dirty.

According to an example, when the purity index is a decimal number, it is directly proportional to the opacity of the fluid.

Alternatively, the variable representing the hue of the fluid is a class indicator among a plurality of classes, each class corresponding to a predefined hue of fluid.

In an unrepresented variant, estimation module 52 is implemented as a programmable logic component, such as an FPGA (Field Programmable Gate Array), or an integrated circuit, such as an ASIC (Application Specific Integrated Circuit).

When calculation unit 50 is implemented as one or more software programs, i.e., as a computer program, also called a computer program product, it is further able to be recorded on a medium readable by a computer, not represented. The computer-readable medium is, for example, a medium capable of storing electronic instructions and being coupled to a bus of a computer system. For example, the readable medium is an optical disk, a magneto-optical disk, a ROM memory, a RAM memory, any type of non-volatile memory (for example, FLASH or NVRAM), or a magnetic card. A computer program including software instructions is then stored on the readable medium.

Device 14 advantageously includes a human-machine interface 54, connected to calculation unit 50, to display information for the attention of a user. Alternatively, or in addition, human-machine interface 54 is used by the user to control device 14. Human-machine interface 54 then typically includes a display screen, as well as optionally an input device, such as a keyboard and a mouse, not represented.

The artificial intelligence model is pre-trained, advantageously by machine learning, for example, via supervised learning, as known in itself.

The training of the artificial intelligence model is typically carried out from training data sets, each training data set including input training data corresponding to the input variables of the model, namely the parameters representing light intensity for the given color channels, and output training data corresponding to the expected fluid hue representative variable, i.e., target, for this input training data. The training of the model is then, for example, carried out via back-propagation of an error gradient, the error being calculated from a difference between the output training data and the output variable estimated by the model from the input training data, i.e., from the difference between the target representative variable and the estimated representative variable for this input training data.

The artificial intelligence model is, for example, a random forest, a support vector machine or SVM model, or a neural network, or ANN (Artificial Neural Network).

In the case of a neural network, it includes an ordered succession of neuron layers, each taking its inputs from the outputs of the previous layer.

More precisely, each layer includes neurons taking their inputs from the outputs of the neurons of the previous layer, or from the input variables for the first layer.

Alternatively, more complex neural network structures are considered with a layer that may be connected to a layer further away than the immediately preceding layer.

Each neuron is also associated with an operation, i.e., a type of processing to be performed by the neuron within the corresponding processing layer.

Each layer is connected to the other layers by a plurality of synapses. A synaptic weight is associated with each synapse, and each synapse forms a connection between two neurons. It is often a real number, which takes positive and negative values. In some cases, the synaptic weight is a complex number.

Each neuron is capable of performing a weighted sum of the value(s) received from the neurons of the previous layer, each value being then multiplied by the respective synaptic weight of each synapse, or connection, between the neuron and the neurons of the previous layer, then to apply an activation function, typically a non-linear function, to the weighted sum, and to deliver at the output of the neuron, in particular to the neurons of the next layer to which it is connected, the value resulting from the application of the activation function. The activation function allows introducing a non-linearity in the processing performed by each neuron. The sigmoid function, the hyperbolic tangent function, the Heaviside function are examples of activation functions.

Optionally, each neuron is also capable of applying, in addition, a multiplicative factor, also called bias, to the output of the activation function, and the value delivered at the output of the neuron is then the product of the bias value and the value from the activation function.

A method for determining the hue of the fluid circulating in flow circuit 12 is now described. The method is implemented by device 14.

The fluid, for example, the paint or the aerosol, circulates in distribution system 10, in particular, in fluid flow vein 16 of device 14. The fluid is colored, opaque, or possibly translucent, or even transparent.

During an emission operation 100, light source 22 emits polychromatic or monochromatic light towards the fluid, in measurement area 23. In particular, the light is emitted through illumination optical fibers 34 to their ends located in flange 13. The fluid circulating in measurement area 23 is thus illuminated by the light through observation window 40.

The light reflected by the fluid forms a light signal, which corresponds to the optical reflection by the fluid of the light emitted by light source 22. The light signal represents the hue of the fluid.

The light signal circulates from measurement area 23 through acquisition optical fiber 36 to light sensor 24, which receives the light signal during a reception operation 102. The light signal received by light sensor 24 is attenuated, due to optical fibers 34 and 36, which cause attenuation dependent on their length, and the wavelengths composing the light on the one hand, and the light signal on the other hand. More precisely, the light is attenuated when it circulates in illumination optical fibers 34, and the light signal is attenuated when it circulates in acquisition optical fiber 36.

Opaque flange 13 advantageously enables strongly limiting any possible light pollution from the external environment, and thus the light signal received by light sensor 24 during reception operation 102 is as reliable as possible, with the least external light pollution.

Light sensor 24 converts the received light signal into parameters, each parameter representing the light intensity of the light signal for a given color channel. In the example, light sensor 24 converts the light signal into four numbers between 0 and 255, corresponding to the light intensity for each channel in the RGBC system.

Calculation unit 50, estimation module 52 in particular, receives the parameters during a reception operation 104.

Estimation module 52 determines the variable representing a hue of the fluid via the artificial intelligence model during a determination operation 106. Each parameter representing the light intensity of the light signal for a given color channel is a respective input variable of the artificial intelligence model. The output variable of the artificial intelligence model is the variable representing the hue of the fluid.

Advantageously, once the variable representing the hue of the fluid is determined by estimation module 52, a message representing the variable representing the hue of the fluid is displayed on human-machine interface 54, in visual form, and/or possibly in sound form, during a display operation 108. Alternatively, during display operation 108, calculation unit 50 sends a message representing the variable representing the hue of the fluid to a remote terminal, for example, a computer or a mobile phone of a user who then constitutes human-machine interface 54.

Advantageously, the method is implemented by device 14 to perform any of the following three tasks.

A first task is estimation of the purity of the fluid circulating in fluid distribution system 10. Such a task is performed, for example, during a rinsing of system 10, by the cleaning liquid. In this case, the variable representing a hue of the fluid is the fluid purity index, and the fluid purity index is in the form of a decimal number. For example, the fluid purity index is a decimal number between 0 and 1, or between 0 and 100. The fluid purity index corresponds to the purity of the fluid circulating in system 10. During a rinsing operation, system 10 is initially dirty, and the variable representing the hue of the fluid will, for example, be substantially equal to zero. Then, as the rinsing progresses, if the hue determination method is repeated over time, the value of the variable representing the hue of the fluid increases, to become substantially equal to 1 or 100, for example, when the fluid is pure, corresponding to a perfectly clean system 10.

A second task is binary classification of the purity of the fluid. In this case, the variable representing a hue of the fluid is the fluid purity index, this index then being in the form of a binary number. Preferably, the purity index is then the class indicator among the first class, corresponding to the case where the fluid is clean, and the second class, corresponding to the case where the fluid is dirty. This task is, for example, performed during a rinsing of system 10, to determine whether or not system 10 is clean.

The fluid purity index notably enables determining if system 10 is clean or dirty, for example, during a rinsing operation. Indeed, if the fluid is considered dirty, in other words, if the purity index determined by the model indicates the class corresponding to the dirty fluid, then system 10 is considered dirty, and if the purity index determined by the model indicates the class corresponding to the clean fluid, then system 10 is considered clean.

Advantageously, in the case of the first and second tasks, the variable representing the hue of the fluid represents the opacity of the fluid, the fluid being considered dirty when it is opaque, and considered clean when it is transparent.

A third task is determining the hue of the fluid, among a palette of predefined hues. In this case, the variable representing a fluid hue represents the color of the fluid. The variable representing a fluid hue is then the class indicator among the plurality of classes, each class corresponding to a predefined fluid hue. This task is, for example, performed to verify that the hue of the fluid circulating in system 10 is indeed the expected hue.

Advantageously, in the case where calculation unit 50 is configured to perform several of the three tasks, separate models, trained separately, are used for each task. The user indicates, for example, which task they wish device 14 to perform, and calculation unit 50 then uses the associated model.

Advantageously, in the case where a user wishes to perform only the first and/or second task, light source 22 is configured to emit only monochromatic light. In particular, monochromatic light is sufficient to evaluate the opacity of the fluid, and thus for the model to determine the variable representing the hue of the fluid reliably. The training of the model is then also carried out with monochromatic light.

Advantageously, the determination method is performed continuously, and the successive values of the variable representing the hue of the fluid are stored in the memory of calculation unit 50.

Optionally, calculation unit 50 detects a fluid change operation when the variable representing the hue of the fluid is modified compared to the variable representing the hue of the fluid previously determined during a detection operation 110, particularly in the case of a variation of the variable representing the hue of the fluid greater than a predetermined threshold. In the case where the variable representing the hue of the fluid is a class indicator, the variable representing the hue of the fluid is considered modified when the class indicated by the variable representing the hue of the fluid is modified. In the case where the variable representing the hue of the fluid is a binary number, the variable representing the hue of the fluid is considered modified when the value of the binary number changes; or, alternatively, in the case of a decimal number, when the value of the number varies by at least 10%. Advantageously, the user himself chooses the necessary variation for the variable representing the hue of the fluid to be considered modified. The fluid change operation is advantageously a rinsing or a hue change of the fluid circulating in system 10.

Advantageously, with a fluid change operation having been detected at detection operation 110, when the successive variables representing the hue of the fluid are substantially constant for a predetermined duration, calculation unit 50 determines that a hue change operation or a rinsing operation is completed, during a determination operation 112.

In the case where the variable representing the hue of the fluid is a decimal number, substantially constant means that a variation of the variables representing the hue of the fluid determined successively by the artificial intelligence model is less than 10% for a predetermined duration, preferably less than 5% for the predetermined duration. In the case where the variable representing the hue of the fluid is a binary number or a class indicator, substantially constant means that the variables representing the hue of the fluid determined successively by the artificial intelligence model are identical, i.e., unchanged.

When the variable representing the hue of the fluid is substantially constant for a predetermined duration, it means that the hue of the fluid circulating in system 10 has stabilized. In the case of a hue change, it means that the desired hue is obtained, and in the case of a rinsing, it means that the system has been completely rinsed. Advantageously, calculation unit 52 commands a specific display on human-machine interface 54, or a sending of a specific message to the remote terminal when the fluid change operation is completed.

The predetermined duration used to consider that a variable is stable is between 0.5 and 5 seconds, for example.

Alternatively, or in addition, device 14 is configured to transmit the variable representing the hue of the fluid to a control unit configured to control a valve or a set of valves of distribution system 10 based on the variable representing the hue of the fluid. Thus, it is possible, for example, to optimize hue change operations, or to adjust the composition of the fluid to obtain the desired hue.

In addition to the above description relating to the learning, i.e., training, of the model, the training of the model is, for example, carried out in the form of supervised learning. The model receives as input data including series, formed of parameters representing a light intensity of the light signal, for a given color channel. The series correspond to data provided by a light sensor belonging to a hue determination device including illumination and acquisition optical fibers of a predefined length. Each series is associated with a class, or a decimal number, depending on the task on which the model is trained. The model then learns to make a prediction and is trained until satisfactory performance is obtained. Performance validation operations of the model are advantageously carried out.

The model is then integrated into the estimation unit of device 14, whose optical fibers 34 and 36 advantageously have the same length as those used for the training of the model. This enables obtaining more reliable predictions by the artificial intelligence model.

Alternatively, the artificial intelligence model is trained by reinforcement learning. Thus, while the model is in use to determine the hue of a fluid, a user indicates, for example, whether the model's predictions are correct or not, and the user's feedback is taken into account by the model in its future predictions. Reinforcement learning is advantageously carried out on an already trained model and allows refining the model's predictions.

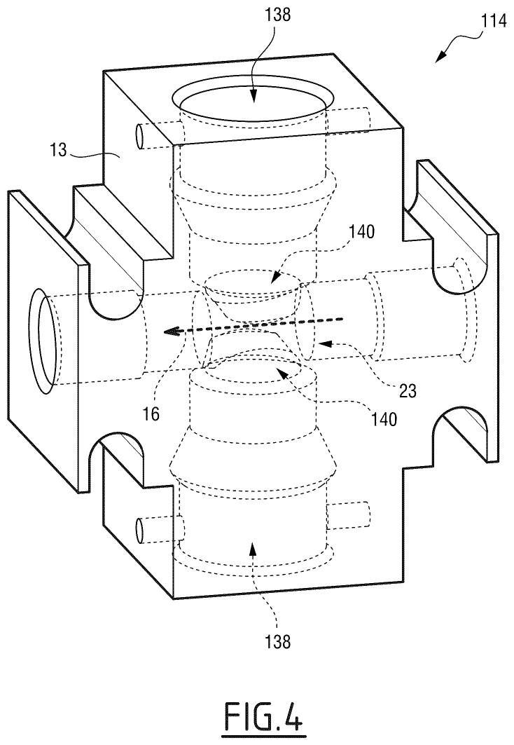

FIG. 4 represents a flange 13 of a hue determination device 114 according to a second embodiment of the invention. Hue determination device 114 is configured to perform a hue measurement by transmission of the light signal through the fluid. In this case, flange 13 of hue measurement device 114 advantageously includes two recesses 138 to insert on the one hand the ends of illumination optical fibers 34, and on the other hand acquisition optical fiber 36, and two observation windows 140 arranged tangentially to fluid flow vein 16 that crosses a measurement area 23, each observation window being at the bottom of one of recesses 138. Advantageously, observation windows 140 are facing each other.

The fluid determination method is unchanged, except that the light signal corresponds to the optical transmission, by the fluid, of the light emitted towards the fluid by light source 22.

Any feature described for one embodiment or variant in the above may be implemented for the other embodiments and variants described previously, as long as technically feasible.

1. A calculator for a hue determination device for a fluid distribution system, the calculator comprising:
at least one light source emitting polychromatic or monochromatic light towards the fluid in a measurement area;
a light sensor receiving a light signal that has been reflected on the fluid or transmitted through the fluid, the light signal corresponding to an optical reflection or to an optical transmission by the fluid, respectively, of the polychromatic or monochromatic light emitted towards the fluid, the light signal representing a hue of the fluid circulating in the fluid distribution system, the light sensor being further configured to emit parameters, each parameter representing a light intensity of the light signal for a given color channel;
an acquisition optical fiber conveying the light signal to the light sensor; and
an estimator receiving the parameters emitted by the light sensor, and determining a variable representing a hue of the fluid via a pre-trained artificial intelligence model, each parameter representing a light intensity of the light signal for a given color channel being an input variable of the model, an output variable of the artificial intelligence model being the variable representing a hue of the fluid, wherein the variable representing the hue of the fluid is either a purity index of the fluid circulating in the fluid distribution system, or a class indicator among a plurality of classes, each class corresponding to a predefined fluid hue.

2. The calculator according to claim 1, wherein the purity index is a decimal number.

3. The calculator according to claim 1 wherein the purity index is comprised between 0 and 1.

4. The calculator according to claim 1, wherein the purity index is a binary number.

5. The calculator according to claim 1, wherein the purity index is a class indicator among a first class corresponding to the case where the fluid is clean, and a second class corresponding to the case where the fluid is dirty.

6. The calculator according to claim 1, wherein the fluid is a coating liquid or a cleaning liquid or an aerosol composed of solid, colored particles suspended in a gas.

7. A hue determination device for a fluid distribution system, comprising:
at least one light source configured to emit polychromatic or monochromatic light towards the fluid in a measurement area;
a light sensor configured to receive a light signal that has been reflected on the fluid or transmitted through the fluid, the light signal corresponding to an optical reflection or to an optical transmission by the fluid, respectively, of the polychromatic or monochromatic light emitted towards the fluid, the light signal representing a hue of the fluid circulating in the fluid distribution system, the light sensor being further configured to emit parameters, each parameter representing a light intensity of the light signal for a given color channel;
an acquisition optical fiber configured to convey the light signal to the light sensor; and
a calculator according to claim 1.

8. The device according to claim 7, wherein the given color channels are red, green, blue, and clear channels, the parameters representing a light intensity of the light signal respectively for the red channel, the green channel, the blue channel, and the clear channel.

9. A fluid distribution system comprising:
a fluid flow circuit; and
a hue determination device according to claim 7, connected in series to said fluid flow circuit.

10. A method for determining the hue of a fluid circulating in a fluid distribution system, implemented by a hue determination device according to claim 7, the method comprising:
emitting polychromatic or monochromatic light towards the fluid by the at least one light source;
receiving, by the light sensor, the light signal, reflected on the fluid or transmitted through the fluid;
receiving, by the estimator, the parameters representing a light intensity of the light signal for the given color channels; and
determining by the estimator, the variable representing the hue of the fluid.

11. The method according to claim 10, further comprising:
detecting a fluid change operation when the variable representing the hue of the fluid is modified, the fluid change operation being a rinsing of the system or a hue change of the fluid circulating in the system; and
with a fluid change operation having been detected, determining an end of the fluid change operation, when the variable representing the hue of the fluid is substantially constant for a predetermined duration.

12. The method according to claim 10, wherein the fluid is a coating liquid or a cleaning liquid.
